(19) United States
(12) Patent Application Publication
(10) Pub. No.: US 2007/0198486 A1
(43) Pub. Date: Aug. 23, 2007

(54) INTERNET SEARCH ENGINE WITH BROWSER TOOLS

(76) Inventors: Daniel Abrams, Los Angeles, CA (US); Sami Vaaraniemi, Helsinki (FI)

Correspondence Address: GOTTLIEB RACKMAN & REISMAN PC, 270 MADISON AVENUE, 8TH FLOOR, NEW YORK, NY, 100160601, US

(21) Appl. No.: 11/466,826

(22) Filed: Aug. 24, 2006

Related U.S. Application Data
(60) Provisional application No. 60/712,155, filed on Aug. 29, 2005.

(51) Int. Cl. G06F 17/30

(52) U.S. Cl. 707/3

(57) ABSTRACT

A system and method for searching the Internet is presented wherein the search results are ordered and selected using one or more preference tools. One such tool consists of the user defining a reference index number that is employed to prioritize and re-rank at least some of the sites obtained by the search, comparing each site's parameters to the reference index number. Each index number includes several parameters in a preset order, each parameter being assigned a quantized relevance based on particular search criteria. Another tool makes use of at least one bundle of websites having particular user-settings designating credibility or trustworthiness. Websites from the search results are then accepted or ordered based on the contents of the bundles. Other tools adjust search criteria based on a desired number of search results and separate browser cookies into (1) those personally trusted and (2) all other cookies that are routinely purged.

### RELATED APPLICATION

This application claims priority to U.S. Provisional Application Ser. No. 60/712,155 filed Aug. 29, 2005.

### BACKGROUND OF THE INVENTION

1. Field of the Invention

This invention pertains to a novel search engine that has a plurality of useful personalization tools that accelerate and enhance the reliability and value of Internet searching.

2. Description of the Prior Art

The Internet is the greatest innovation for research in all of human history. It consistently increases in scope and depth at a geometric rate. It is conceivable that the sum of all knowledge will be accessible online. But there are only so many hours in a lifetime. Consequently the fraction of the total available knowledge that any one person can accrete is forever decreased. Time is the scarcest resource. Efficiency is the only viable means of dealing with such scarcity.

Google, Yahoo, Microsoft and their myriad competitors have capitalized on this problem by providing search engines. By providing users with better searches they provide users with listings of web sites related to some desired content. However, in their present form, these search engines leave much to be desired. Yahoo & Google claim to have indexed billions of web pages. Consequently, for any given search term they might yield hundreds of thousands of results. But if most users barely go beyond the first 100 results what good are the remaining thousands? This problem will only get worse as more people get on the net and ever more pages are created. The crucial issue becomes not only relevancy but credibility. How much more believable should a random website be than simply calling someone randomly out of the phone book? Just because somebody wrote a fact on a webpage does not necessarily make it true. Just because a result matches a keyword search does not necessarily make it trustworthy.

### SUMMARY OF THE INVENTION

The invention pertains to a search engine with a number of useful browser tools that accelerate, simplify and help organize the results of Internet searching according to unique user-selected or user-defined preferences. The tools can be used with a standard search engine, as an interface enabling the user to enhance the searching experience using commonly accessible Internet search engines. In one aspect of the invention, a reference index number is determined by assembling a plurality of parameters in a preset order, each parameter having values associated with the predetermined priority value of websites to a search. The parameters are quantized representations of various relevance criteria such as recency, density, credibility, or genre. Then a search is conducted, site index numbers are determined for at least some of the resulting web sites and the site index numbers are compared to the reference index number to determine the relevance of the respective websites.

In another aspect of the invention, known websites are arranged or partitioned into bundles according to their trustworthiness and other similar criteria. Search results in the form of websites obtained from searches are then accepted and/or ordered for presentation to a user based on the contents of at least one of the bundles. Bundles are compiled either by the user or by others and can be exchanged between the users.

A further aspect of the invention is that user can specify a target number of websites for search results. An Internet search is then conducted using search terms from a user and a set of search criteria and the resulting number of sites is adjusted to conform to the target number by modifying the search criteria.

Yet further aspects of the invention include “invites”, “merging multiple bundles”, “combination of keystrokes”, “integration with the operating system”, “automatic updates”, “find potentially well-suited bundles”, “bundle tracking”, “bundle crowds”, and “monitoring search criteria” tools.

Thus, although the invention is somewhat more involved compared to current search engines, the tradeoff of using these tools—a little extra time to fill in the required parameters—is well worth obviating the dead ends that the currently available search engines produce.

### BRIEF DESCRIPTION OF THE DRAWINGS

The features and advantages of the present invention will become further understood with reference to the following description, appended claims and accompanying drawings, in which:

FIG. 1 is a flowchart showing the initial setup of the bundle user preferences in the system of the present invention;

FIG. 2 is a flowchart showing performing a search the system and method of the present invention employing an index number and/or bundles;

FIG. 3 is a flowchart showing performing a search using the system and method of the present invention employing an index number;

FIG. 4 is a flowchart showing performing a search using the system and method of the present invention employing bundles;

FIG. 5 shows a block diagram for a system performing searching using SearchStyles; and

FIG. 6 shows a block diagram for a system performing searching using bundles.

### DESCRIPTION OF THE PREFERRED EMBODIMENTS

The present invention provides a system for performing searches in on the Internet using a search engine and several tools that allow users to search efficiently for relevant and credible websites. As will be come apparent from the following description, most of the tools can be used independently of each other, and, accordingly, any number of these tools can be added to a browser as desired. These tools are now described.

Target Number

A typical query to Google may result in the delivery of a search in 0.32 seconds containing some 450,000 sites. Reviewing these sites is almost impossible.

The present system provides a solution to this problem. In one embodiment, a user specifies ahead of time a target number of sites. The present system runs a search and checks the number of sites returned. If there are too many sites, the system eliminates sites by increasing the selectivity of some search criteria until the target number is reached. Alternatively, or in addition, the system can also eliminate redundant sites, based on similarity in addresses, size, number of pictures, etc. If there are too few sites, the search is repeated using broader criteria. For example the search criteria may be the so-called SearchStyle described below, in which some of the parameters, such as recency or credibility are adjusted or the search terms may be associated with an “or” rather than an “and” connector.

Once the target number of site has been obtained, the sites are displayed to the user. In one embodiment, a toggle switch is used to select either a grouped or a varied presentation styles. The grouped styles pertain to displaying many similarly associated results on the same page. Varied presentation style do just the opposite and list different types of sites in an alternating fashion so as to provide maximum diversity on each returned results and to enable more efficient scanning.

In the “grouped display” embodiment, results from the same domains could be collapsed into a single representative result when the search results are presented to the user. If the user selects the “more like this” link, then the other similar sites would be displayed. This could be taken further in an alternate embodiment where results found to have identical lines are similarly grouped together (if “X” number of words are identical then the web pages are considered effectively similar).

SearchStyles

An important feature of the invention is termed “SearchStyle” and it presents a giant paradigm shift in the field of search technology. Currently, all the big search engines treat users the same. Their assumption is that, if two people type in the same three words, they are probably looking for the same information. This approach is not applicable in many instances. What if those three words are “Bush”, “Economic” and “Record”? If one of those people is in a “red state” and the other is in a “blue state” they will likely want different sources of information. The “SearchStyle” feature provides an efficient method of tailoring searches to the user's priorities.

More particularly, the “SearchStyle” feature of the present invention provides a novel means of searching & browsing that provide more accurate and credible results then the prior art. Presently, a search engine such as Google, Yahoo or other similar engines, is performed as follows:
a) First the user generates a number of key words associated with, or characteristic of the search;
b) The key words are entered into the search engine and the search engine returns a slew of web sites covering several pages;
c) Sometimes the user gets lucky and something interesting shows up on the first page. But in most instances the first page shows only very few sites of interest, and the user has to plough through several pages and hope to find the other site of interest.
   Of course, the number of sites returned by a search can be decreased by increasing the number of key words; however, the engine may return only a few matches that may not be necessarily relevant.

In the alternative, those sites let you use the “advanced settings” which include overly complicated and confusing Boolean structure and require perfect proficiency in logic. Moreover there is no guarantee that this technique will result in better matches.

As discussed above, one of the reasons that a broad search returns a large number of results is that the search engines do not take into account the personal preferences of individuals. The same way that you can't get ten people in a room to agree on the best films, music, fashion or food, you can't expect the same people to agree on what sites from a search engine are best for a given search. Thus, the currently leading search engines aren't satisfying their customers. With the search means described herein, more accurate results are provided that are better suited to the user. Generally speaking, when properly set up, the application will not generate two searches with the same results except if that is what is desired.

Preferably, the SearchStyle feature is an option that can be incorporated into any standard “search terms” field of any standard search engine. The SearchStyle feature refers to a process for weeding out sites obtained from a search by calculating a site index number for each such site and comparing it to a preselected or reference index number. These index numbers consist of several digits. In one embodiment, the index number is a five digit number that defines a user's priorities, preferences, or guidelines, each digit being associated with a particular parameter. By selecting values for these parameters, the user provides an overlay on the results returned by a search engine thereby providing the above-mentioned improvements and advantages. It should be understood that the order of these parameters or digits is not crucial and the parameters can be presented in any order, as long as the order is well defined. Moreover, as discussed below, some of the parameters may be omitted and/or replaced by other parameters. For the sake of identification, the five parameters are designated herein as parameters A, B, C, D and E.

A. Recency

This parameter defines a preferred time period. A numerical value is used to each time period as follows:
0—within 6 hours
1—within 24 hours
2—within One week
3—within One month
4—within Six months
5—within One year
6—within Two years
7—within Five years
8—within Ten years
9—unlimited

For example, a user selects “3” if he wants to review only sites generated or updated within the last month. Of course, these assignments are arbitrary and other assignments and time periods can be used as well. In another embodiment, once results are returned, the user can sort by any search style criteria and the results can be presented to the user in any convenient format.

B. Density

This parameter defines how many of the search terms must be present. This feature is clearly an improvement over standard Boolean search tools because it allows for more terms to be used in the initial search request thereby preventing an inefficiently iterative process.

The numerals can be assigned to density as follows:
0—Under 20% of entered search terms are required
1—Under 40%
2—Under 60%
3—Under 80%
4—100% of entered search terms must be present on the found site
5—100% of entered search terms must be present on the found page
6-9—How close must be they be together within the page.

Finally, the system can also add a weight for the size of a website. For example, a website with 60 paragraphs that include search terms is weighted more heavily than a site with one paragraph. Some existing search engines have a feature that allows a user can define how close together the terms should be (e.g. find the keyword ‘movie’ within ‘8’ words of the keyword ‘reviews’.) In a similar manner, numerals 6-9 are used in the present invention to provide an indication of close are the search terms to each other.

C. Credibility

This parameter provides a measure of how reliable a site should be. The user can define his preferences of what kinds of sites are excluded and included. If the user does not make his own choices, the system may provide a default value. Alternatively, templates that define tiers of trusted and distrusted domains can be created, traded and modified among fellow users. External/objective sites will be able to share their own lists of credible sites. For example, medical journals could list sites of researchers they've published, Political Parties can list their favorite sources, etc. This affiliation status maybe an alternate and more specific collection of Blacklists/Good Lists that users can employ. Much like a “Good Housekeeping Seal of Approval” or a “Consumer Reports rating” anyone can create a hierarchy of trusted domains. This tier system can be organized with a user's absolute favorite sites (group “1”). Then there could be the user's personally vetted and selected domains at the top (group “2”). Then there could be a list of sites your personal contacts have determined to be credible (group “3”). Then there could be a list of sites that your favorite organization has determined to be credible (group “4”). Then that list could have their own respective lists of domains they determine to be credible (group “5”). This is an arbitrary classification. Alternatively, the user could set tiers however she saw fit. “SearchStyle” credibility numerals may be assigned to this parameter as follows:
0—None required
1—Exclude blacklisted sites. A list of blacklisted sites is maintained by the system (similar to the way software companies maintain databases that track viruses) and the user can download the list, and optionally add or eliminate sites from the list.
2—Excluded general gray list. The system maintains a list of sites discredited by consumer organizations, better business bureaus, and other similar organizations and the user can optionally add his own entries.
3—Excluded unvetted domains. The system authenticates the sites to prevent listing phony sites.
4—Restricted to general good list or better. The system maintains a list of sites known to be credible or reliable (considering duration of existence, small number of complaints, investigations etc).
5—Restricted to user-set group “5” or higher (with group “5” results ranking below group “4”, which would be below “3”, which would be below “2”, which would be below “1”.)
6—Restricted to group “4” or “3” or “2” or “1” (with group “4” results ranking below “3”, which would be below “2”, which would be below “1”.)
7—Restricted to group “3” or “2” or “1” (with group “2” results having higher priority and ranking than “3” but lower than “1”).
8—Restrict to group “2” or “1” domains. (With group “1” results having higher priority and ranking).
9—Restricted to group “1” domains/sites.

D. Genre

This is a user defined parameter related to the preferences of the user and/or the kind of information being sought. Numerals may be assigned to this parameter as follows:
0—None
1—News
2—Research sites
3—Online Merchants/Sales sites
4—Entertainment Sites

Of course any number of definitions may be used for this parameter.

E. Custom

This parameter is selectable by the user and maybe related to language, region, price, size of downloadable items in megabytes, password requirements, cookie requirements, expertise, etc. In the case of “expertise” the search results could be prioritized for the level of the user. On a sliding scale, low numbers could indicate accessibility for kids and a level of writing requiring limited education, etc. Middle numbers could indicate greater education is probably necessary for full comprehension. Higher numbers could indicate saturation of jargon and high level of expertise. The success of “How to ______ for Dummies” prove that there is a real need for easy to read material. On the other hand hardcore researchers are often frustrated with the “mile wide/inch deep” level of thoroughness on the majority of the web. The present system could use surveys to discern the level of expertise. In an alternate embodiment, search bots with rudimentary AI (similar to Microsoft's Grammar checker) are used to flag sites with their level of expertise. These sites are then graded and incorporated in the list of search results.

As discussed above, while the preferred embodiment, five parameters are used, this number can be increased. For example, in an alternate embodiment, seven to ten parameters may be used for super-advanced users with very specific needs.

In one embodiment, the system checks the sites before they are presented to the user to weed out dead sites. Uncorroborated sites are dumped before the user sees them in order to prevent the frustration of clicking on a dead link.

In one embodiment, a search is conducted, and only the websites having an index number that is identical to the preselected or reference index number are accepted and other sites are rejected. In other embodiments, sites are accepted if all or some of the parameters of their index numbers are within some predetermined range of the respective parameter in the preselected index number. For example, an additional variation parameter V may be defined in the system as the parameter defining the range of any parameter used for calculation of the index number. The parameter V can be defined as any unit available in the respective parameter of the index number (such as time or calendar units for recency, for example: hours, days, months, years, etc.). Thus, a user selecting “4” for recency (six months) with a V parameter set to one (1) month (i.e., plus/minus one (1) month), would produce all results between five and seven months. Such ranges may be used for all the parameters used in calculation of the index number to give the user further flexibility in defining the desired output of results.

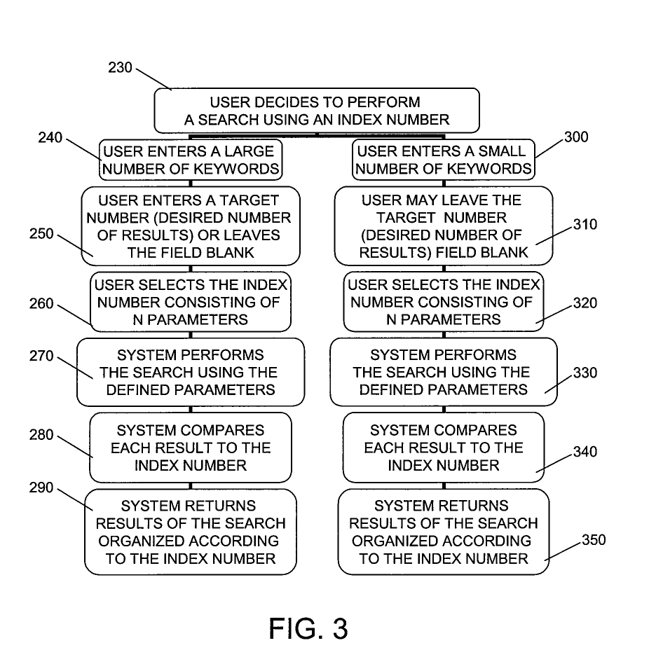

FIG. 3 illustrates a typical search using the SearchStyle feature and it operates as follows. First, the user decides to perform a search using an index number (step 230). Then the user enters a number of keywords (steps 240 or 300), which can be a large or small number. The user may also enter a target number (desired number of results to be returned) (step 250) or leave the target number field blank (step 310). Then the user selects the reference index number consisting on N search parameters in steps 260 or 320. After that, the system performs the search using the defined parameters (steps 270 or 330), compares the index number of each obtained site to the reference index number (steps 280 or 340), and returns sites that with matching index numbers (steps 290 or 350).

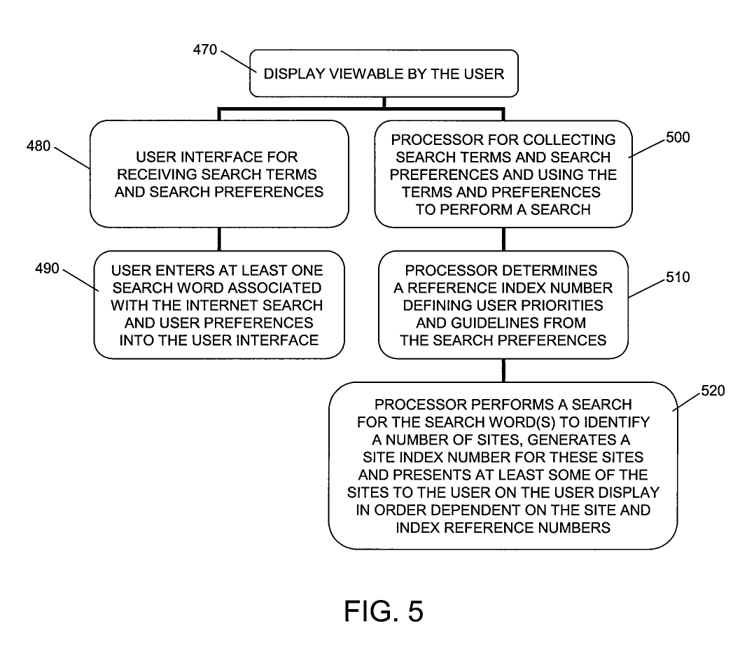

With reference to FIG. 5, the system for performing an Internet search using the SearchStyles reference index number consists of a display viewable by the user 470, a user interface 480 where the user enters one or more search words associated with the Internet search and the user preferences 490, and a processor 500 that receives the search words and user preferences and determines a reference index number defining user priorities and guidelines from these user preferences 510. The processor performs the Internet search for the search words, identifies a number of sites as the result of the search, generates a site index number for these sites, and presents some or all of these sites to the user (on the user display 470) in the order dependent on the site and index reference numbers 520.

Spamming

Importantly, the system significantly reduces the growing problem of “Search Engine Spam”. As well known in the art, email spam is the unwanted commercial junk mail the clogs the Internet and upsets users. Search Engine Spam is just as insidious. In fact, there is a cottage industry devote to increasing a companies placement in non-sponsored search results. The major search engines are constantly playing cat-and-mouse with spammers altering their algorithms (and going to great lengths to keep them secret) to intercept or ignore spam. The major metasearch engines hope that by utilizing multiple search engines spammers won't be able to effectively corrupt all the files and that the search engines will return some effective results in response to queries.

The present system uses an entirely new approach based on generating lists of trusted cites or domains. These lists are assembled from cites known to be free of spam. Therefore users relying on these lists are assured that they will not be subjected to spam.

Bundles

At present, most searches are implemented by having a user specify one or more search terms that may or may not be associated with each other using Boolean operators. However, the search itself is then either a very closed search within a specified website, or a wide open search covering literally the whole Internet. The problem with the first type of search is that it is very limited. The problem with the second is that the search engine most often returns thousands of hits and a user has a hard time dealing with these hits. Some existing solutions use their search engines to search exclusively through the search engines' selection of sites, therefore completely ignoring potentially useful web pages and unnecessarily restricting the search universe. In the present invention, this problem is resolved by the bundles, which are a user-created hierarchy of websites, which prioritize the search results according to the user's ranking. The individual user does not have to create a bundle to use it because bundles may be exchanged between users or default bundles may be provided by the search engine. For example, search results from “Loved” sites are presented first, “Liked” sites second, “Unknown” sites third, “Disliked” sites fourth, and the results from “Blacklisted” sites are expunged completely. The present invention, thus, prioritizes favorite sites and assigns a low level of priority to distasteful sites (such as those in the “Disliked” category). The search of the entire web is typically conducted and the results are ranked based on the bundle preferences, but the search can also be conducted only within the websites listed in the bundle with the respective preference for each website.

This is accomplished by establishing collections of domains or website that are relevant to a particular subject matter or type of search. Moreover, in one embodiment, the collection of websites or domains is further ordered using some selection rules that arrange the sites or domains in a predetermined hierarchical order before a search. Each of these collections is referred to herein as a bundle. For example, a bundle may be devoted to raising dogs. This bundle can include all the sites found by an individual that deal with this subject.

Each bundle may be generated by professionals, or any one else. Moreover, bundles could be available to any member of the public, can be kept private or can be exchanged between various Internet users.

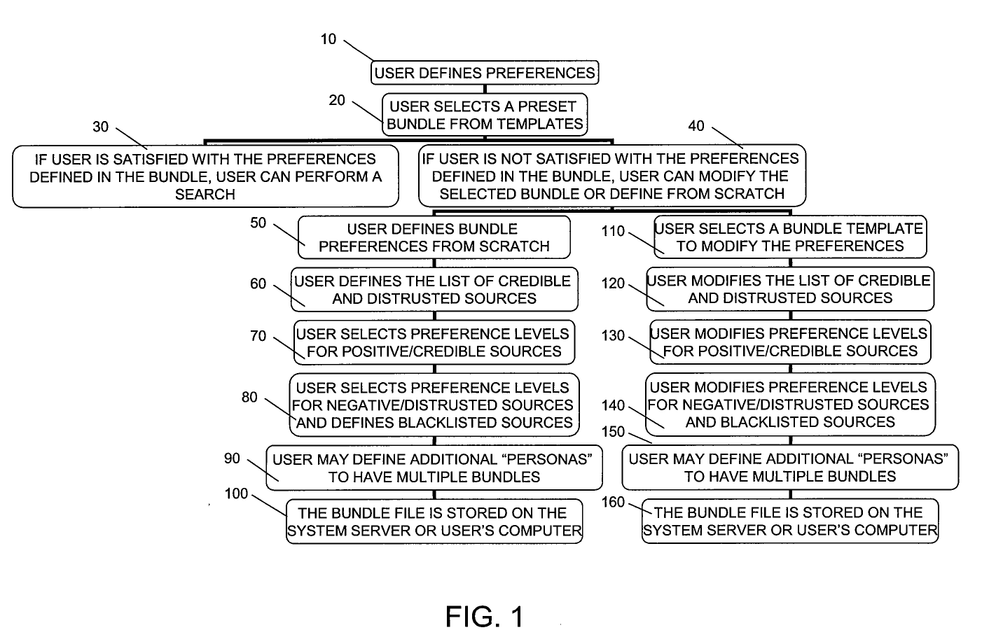

FIG. 1 shows a flow chart for using user preferences to define bundles of sites, each bundle including only the websites that meet certain criteria. More particularly, the sites in any particular bundle can be qualified or ordered based on contents, ease of use, user preferences and so on. Initially, several default bundle templates may be generated and stored on the system server. When the user wants to use a bundle, the user can select a preset bundle from templates (step 20). If the user is satisfied with the bundle, the user can perform a search (step 30). If the user is not satisfied with the preferences defined in the bundle, the user can define a new bundle from scratch (step 50) or select and modify an existing bundle (step 110). Defining the bundle includes the steps of defining the list of credible and distrusted sources (step 60), selecting preference levels for positive/credible sources (step 70), selecting the preference levels for distrusted sources and defining blacklisted sources (Step 80), and possibly defining additional “user personas” that may have different bundles (step 90). Likewise, modifying the existing bundle includes the steps of modifying the list of credible and distrusted sources (step 120), modifying the preference levels for positive/credible sources (step 130), modifying the preference levels for distrusted sources and defining blacklisted sources (step 140), and possibly defining additional “user personas” that may have different bundles 9step 150). Once a bundle is completed, it can be stored on a public or private site (i.e. the system server or the user's computer), shown in steps 100 and 160 of FIG. 1.

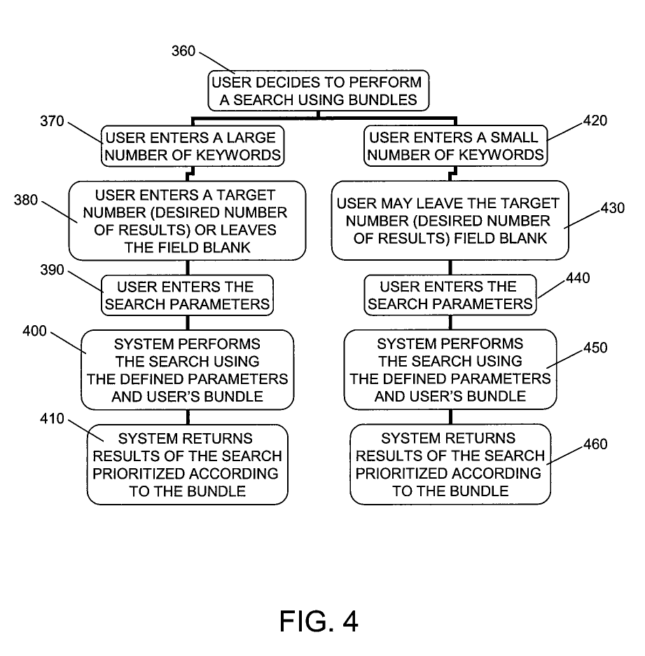

FIG. 4 illustrates a typical search using bundles, which is conducted as follows. First, the user decides to perform a search using bundles (step 360). Then, the user enters a number of keywords (steps 370 or 420), depending on the number of entered keywords, which can be large or small. This is done by a search engine presented to the user a window in which the user enters the search terms (typically into a searchbox). The user may also enter a target number (desired number of results to be returned—step 380) or leave the target number field blank (step 430). Then the user enters the search parameters (steps 390 or 440), in the form of bundles with their respective user-defined preferences. In a separate window, the user is presented with a plurality of bundles, which can be presented in form of a drop-down list, a table or any other convenient form. The user selects one of these bundles. The search criteria are then searched for (i.e., the system performs the search—steps 400 or 450), and the search results are ranked, prioritized and returned according to the parameters defined in the bundle selected (steps 410 or 460). This reduces spam and gives the users much more control over the result-ranking process. The system can use its own search engine or the system can serve as an intermediary or control system for any available Internet search engine.

If the sites are organized in some order, then the search is conducted and/or the results are arranged in the order of the bundle, for example, by presenting all the sites liked by the user generating the bundle, or all the sites that have a certain minimum or maximum size, all the sites from a particular domain (e.g., gov, it, etc.) If the respective bundle is ordered then the results can be ordered as well.

When the user is presented with the search results that are not in the bundle, the user is also presented with a number of icons that allow the user to select the preference level for each search result that is not in the bundle and add that result to his or her bundle. Preferably, at least four icons are used, representing the following categories of preference: “Loves” (denoted by a star for example), “Likes” (denoted by a smiley face for example), “Dislikes” (denoted by a frowney face for example), and “Blacklist” (denoted by an X for example). Other numerous icons and associated symbols may be used to select the preference for a particular search result and add that result with the assigned preference to the user's bundle while the user is viewing the results.

The parameters discussed above together with the associated black lists, white lists, good lists, and other data, can be saved and swapped like Apple's iTunes playlists, favorite websites, myspace.com pages, etc. If a colleague or coworker has developed a good search style, bundle, or a set of lists, he can save his preferences and give them to you to use. A user might have dozens of assorted search style sets of credibility lists that he employs for differing search tasks. A boss or professor can guide her people with pre-approved search styles and credibility lists.

Users may invite other users to sample their bundle. This can be done directly by the user entering in his invitee's email addresses and sending an official bundle invite. Then the invitee may follow that invitation's directions to sign up and make use of that particular bundle. Alternatively, the bundles can be stored as text files (possibly encrypted) and attached to emails, stored on other servers/made available for download on websites. With designated ID numbers and passwords, the bundles can be accessed remotely from anywhere on the Internet.

Users can also merge multiple bundles to create more personalized bundles. After bundles are merged into the user's personal bundles, any manner of modification is possible. For example, if bundle “X” has sites A,B & C and is merged into bundle “Y” which contains sites H, I, J, K & L, the user may remove site B, change the tier of site C and add site W.

Combinations of keystrokes can specify bundle categories for particular domains and whether those attributes apply to only the current bundle, all bundles in the user's account, or some bundles at the discretion of the user.

Additionally, integration with the operating system allows for cursor-selected websites to be added to the bundles from any application. A user can be reading something in MS Word or in an email client and highlight/cursor-select that domain to be automatically added to a bundle.

Another embodiment of bundles would allow the user to get automatic updates to his or her bundles based on his or her designated authorities (i.e., updates to bundles can be submitted to the user for modification of his bundles, possibly using RSS, another widely available “push” technology, or simply on a timed cycle).

Yet another embodiment of bundles enables the users to find potentially well-suited bundles based on the contents of their other preferred bundles. For example, if a user has sites X, Y & Z in the bundle and so does another user, the two users may appreciate each others sources that are not currently in each of their respective bundles. This could be further advanced with sub-rankings within each hierarchy/tier. A user could designate criteria for evaluating other potential bundles (e.g., find bundles where joesfavoritenews.com” is in the “Loves” tier but “Marksnewsarama.com” is in the “Hates” tier).

Once enough users are employing their own bundles, further advancement is possible that (i.e., “bundle tracking”). By tracking the usage of bundles, algorithms can be used to determine sites widely considered “trustworthy” for the general ranking process. Bundle-tracking can be further exploited by grouping users into different “crowds”. Users with similar bundles can be grouped to recommend further bundle modification. These “crowds” of users can be offered the opportunity to formalize their association for the purpose of search or even for social-connections, possibly even for finding a romantic interest.

Furthermore, monitoring of common search criteria can be cross-referenced with the bundle tracking and bundle crowds so that better results could be returned. By coupling this with commonly available results, click-tracking could target results even better based on bundles and crowds.

The bundles concept can be extended to other tools. Friends and coworkers can share bookmarks/sources, search styles, methods, etc. at their discretion. These collections of items can be incorporated into a small file that is easily attached to email and loaded into a browser.

IT departments and technically savvy users can save their preferences as a file to email to a novice friend. If you like the way a friend has their system set up you can use their preferences and then tailor to your own taste as you become more proficient.

The system will enable a user to generate and present any bundle in a single file. At the request of the users, the system can then compare the similarities to other people interested in trading bundles. Appropriate matches will be returned to recommend other, previously unknown websites that he or she is likely to trust.

Moreover, since each bundle is represented as a file having a relatively simple structure, several bundles can be combined into one, portions of bundles can be deleted, and many other editing functions can be performed on bundles with relative ease. The bundles typically reside on the search engine' server so that the user may have access to them from any computer, but, in an alternative embodiment, the bundles may reside on the user's host computer. In either embodiment, the user can easily modify the bundles at his or her discretion.

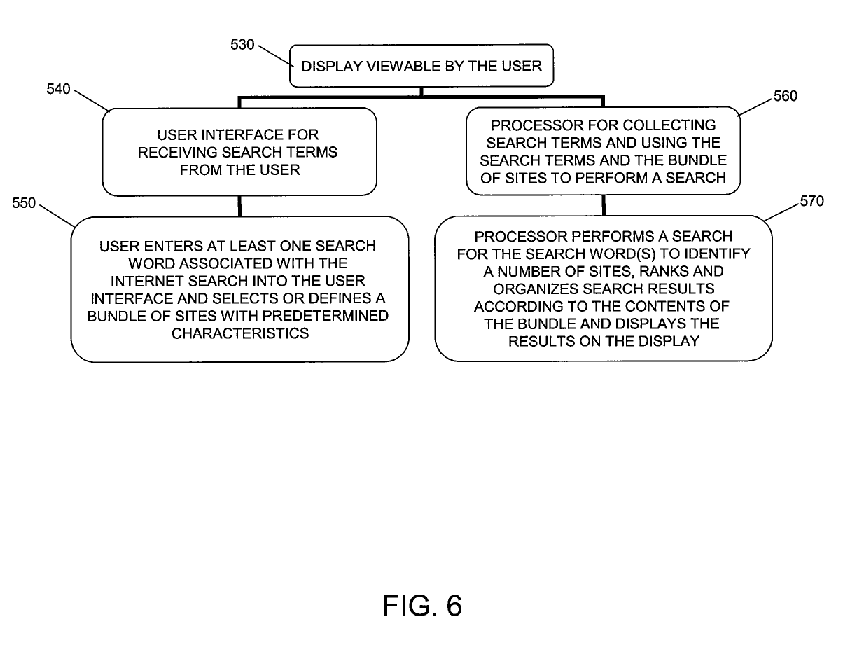

With reference to FIG. 6, the system for performing an Internet search using bundles defining a set of user-trusted websites with predetermined characteristics consists of a display viewable by the user 530, a user interface 540 where the user enters one or more search words associated with the Internet search selects or defines a bundle 550, and a processor 560 that receives the search words and selected or defined bundle. The processor performs the Internet search for the search words, identifies a number of sites as the result of the search, ranks and organizes these search results according to the contents of the bundle, and displays these sites to the user (on the user display 530) in the order dependent on the bundle preferences 570.

A Combination of SearchStyles and Bundles

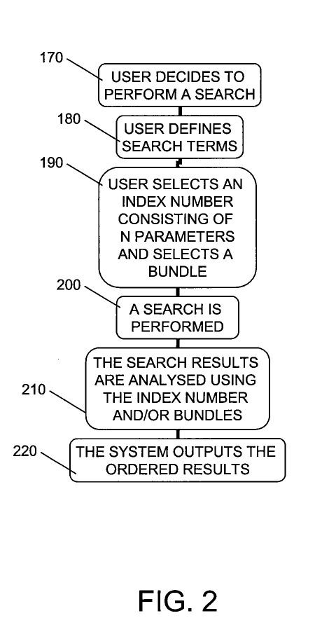

A search utilizing both an index number and bundles may be more advantageous than a search using only one of these tools. A typical search would be performed as follows, as illustrated by FIG. 2: the user decides to perform a search using a reference index number (SearchStyle) and bundles 170. Then, the user defines search terms (step 180), typically by entering search terms or keywords in a window. Next, the user selects a reference index number consisting of N parameters and selects a bundle (step 190). The system then performs a search (step 200) and analyses the search results using the reference index number and/or the bundle selected (step 210) (the results are ranked and organized according to the preferences in the bundle). The system then outputs the ordered results (step 220).

Personally Vetted Cookies (PVC)

Cookies are small data files that websites insert on users' computers in order to customize the experience. A cookie may include profile information, regionalization, preferences and other similar information. Without a cookie a user encounters generic webpage. With a cookie he or she can be provided with a more personalized experience, including local news, weather, previous purchases, recommended purchases and similar beneficial information.

However, cookies can be used for other purposes as well, that may be detrimental to the user. Cookies can retain information that the user wouldn't want to be retained and give rise to privacy issues, spam fears and security concerns. Users deserve and demand control over cookies left by websites on their computer However, currently the methods to implement such controls are clumsy and inefficient. Typically current browsers enable users to prevent cookies (limiting personalization and functionality) or to allow them (enabling the aforementioned problems of privacy, spam and security). Once they reside on the user's computer the user could, on a daily basis, arduously sift through them, deleting unwanted and unrecognized cookies. Mozilla's Firefox is an example of a browser that can be used to manage cookies in this manner but is by and large insufficient But none are remotely close to ideal.

PVC is a cookie manager that creates two folders. The first is a regular cookie folder. The second is for those cookies that the user has determined are worth keeping. For example, a user may decide to keep the cookies for Citibank, USAToday and Amazon but set the browser to regularly delete any others. Now the user is in control but in a fast, stable and ideal way. While visiting a new site a user could with a designated keystroke set that site as one with cookies worth keeping. Otherwise all cookies are regularly, by default, directed to the regular cookie folder that is eventually deleted.

Although the invention is described in terms of particular embodiments, it is to be understood that the embodiments are merely illustrative of an application of the principles of the invention. Numerous modifications may be made and other arrangements may be devised without departing from the spirit and scope of the invention as defined in the appended claims.

What is claimed is:

1. A system for searching the Internet, comprising:
a display viewable by a user;
a user interface for receiving search terms and search preferences; and
a processor for collecting said search terms and said search preferences from the user, and using said search terms and said search preferences to perform an Internet search;
wherein the user enters at least one search word associated with the Internet search and said search preferences into said user interface and said data processor determines a reference index number from said search preferences, said index number comprising a plurality of digits and defining user priorities and guidelines;
and wherein said data processor performs a search for said search word to identify a plurality of sites, generates a site index number for said sites and presents at least some of said sites to the user on said display in an order dependent on said site and said reference index numbers.

2. The system of claim 1 further comprising an Internet search engine for performing the Internet search.

3. The system of claim 1 wherein said index numbers are determined by said processor by selecting at least one of consisting of recency, term density, site credibility as predetermined by the user and site genre parameter.

4. The system of claim 1 wherein said data processor modifies the number of websites returned by increasing or decreasing the selectivity of said index number.

5. The system of claim 1 wherein the user specifies a target number of websites to be returned.

6. The system of claim 1 wherein said data processor checks the search results before they are presented to the user and eliminates dead links.

7. The system of claim 1 wherein said data processor restricts the number of websites returned by eliminating websites having the same root address.

8. The system of claim 1 wherein said search preferences are entered into the system by inputting information into windows.

9. A system for searching the Internet, comprising:
a display viewable by a user;
a user interface receiving search terms from the user; and
a processor for collecting said search terms from the user, and using said search terms and a bundle of sites having predetermined characteristics to perform an Internet search;
wherein the user enters at least one search word and wherein said processor performs a search for Internet websites containing the at least one search word, ranks and organizes search results according to the contents of said bundle and displays said results on said display.

10. The system of claim 9 further comprising an Internet search engine for performing the Internet search.

11. The system of claim 9 wherein the processor receives a user's preferences and defines said bundle.

12. The system of claim 9 wherein said processor saves bundles selected by an individual user.

13. The system of claim 12 wherein said processor recalls a bundle selected by the user and performs the search according to the search preferences defined in said selected bundle.

14. The system of claim 12 further comprising a server, wherein said bundle is saved on said server.

15. The system of claim 9 wherein said processor checks the search results before they are presented to the user and eliminates dead links.

16. The system of claim 9 wherein the user specifies a target number of websites to be returned.

17. A method of searching the Internet comprising the steps of:
receiving a search term from a user;
performing a search using said search term;
receiving a plurality of sites resulting from said search;
ranking and prioritizing the plurality of search results according to the content of a a bundle of preselected websites, said bundle defining levels of trust associated with the preselected websites; and
displaying the prioritized search results to the user.

18. The method of claim 17 further comprising the step of calculating a site index number comprising a plurality of digits for each site, said index number defining user priorities and guidelines and rejecting websites based on whether said site index number meets a predetermined criteria.
